(19) United States
(12) Patent Application Publication
(10) Pub. No.: US 2018/0071774 A1
(43) Pub. Date: Mar. 15, 2018

(54) METHOD FOR MANUFACTURING COMPOSITE FILM

(71) Applicant: Teijin Limited, Osaka-shi, Osaka (JP)

(72) Inventors: Hiroyuki HONMOTO, Osaka-shi (JP); Noboru TANIKAWA, Osaka-shi (JP)

(73) Assignee: Teijin Limited, Osaka-shi, Osaka (JP)

(21) Appl. No.: 15/562,101

(22) PCT Filed: Dec. 24, 2015
(86) PCT No.: PCT/JP2015/086066

§ 371 Date: Sep. 27, 2017

(30) Foreign Application Priority Data
Mar. 31, 2015 (JP) 2015-073079

(51) Int. Cl. B05D 3/02; B29B 13/02; B29C 41/28; B05D 7/02; C08J 7/04; C08J 9/26; C08J 9/28

(52) U.S. Cl. CPC B05D 3/0218; B29B 13/02; B29C 41/28; H01G 11/52; C08J 7/045; C08J 9/26; C08J 9/283; B05D 7/02

(57) ABSTRACT

The embodiment according to the present disclosure provides a method of manufacturing a composite film. This method includes: subjecting a porous substrate containing a thermoplastic resin to a heat treatment at a temperature T which satisfies the Formula: Tg+60° C.≦temperature T≦Tm (wherein Tg represents a glass transition temperature (° C.) of the thermoplastic resin; and Tm represents a melting point (° C.) of the thermoplastic resin); coating a coating liquid containing at least a resin and a solvent on one surface or both surfaces of the porous substrate, which has been subjected to the heat treatment, to form a coating layer, with a tensile stress in a machine direction in the porous substrate adjusted to be within a range in which an elongation of the porous substrate is 2% or less; and solidifying the coating layer to obtain a composite film including the porous substrate and a porous layer containing at least the resin formed on one surface or both surfaces of the porous substrate.

### TECHNICAL FIELD

The present disclosure relates to a method of manufacturing a composite film.

### BACKGROUND ART

Composite films including a porous substrate and a porous layer provided on a surface of the porous substrate are conventionally known as battery separators, gas filters, liquid filters or the like. As a method of manufacturing a composite film, a technique is proposed in which a porous layer is prepared by coating a coating liquid containing an organic high molecular weight compound on one surface or both surfaces of a substrate film to form a coating layer, immersing the resultant in a solidifying liquid to solidify the coating layer, and followed by washing with water and drying, and in which the substrate film is continuously transported through respective processes at a speed of 10 m/min or more (see, for example, Japanese Patent (JP-B) No. 5134526). JP-B No. 5134526 discloses a method in which a porous layer is formed by a wet coagulation method, which is known as a method capable of porosifying a porous layer containing a resin in a favorable manner.

### DISCLOSURE OF THE INVENTION

### Problem to be Solved by the Invention

However, when coating a desired liquid on a substrate in a production process of a secondary battery separator, for example, there is a case in which sagging occurs in a portion of the substrate, or a case in which surface irregularities or variation in thickness is present in the substrate itself. Such unevenness in the substrate not only may lead to unevenness in film thickness of the resulting coating layer, but also may result in occurrence of a coating defect, in some cases, such as presence of an uncoated area which has remained uncoated or an area in which the coating is significantly uneven. In addition, the coating defect may cause a transport failure (such as meandering) of the substrate after the coating.

Further, in a case in which the substrate after the coating is wound about a predetermined core to be formed into a roll, the unevenness in the substrate may also cause the occurrence of marked irregularities on an outermost surface of the resulting roll, or the occurrence of deformation, unevenness or the like at an end portion of the roll. In addition, the resulting product after being subjected to a secondary processing may also have the same poor appearance as described above.

When a tensile force applied to a substrate during the transport is increased, the sagging of the substrate, or the surface irregularities or the variation in thickness of the substrate itself is superficially reduced. However, the application of a more than necessary amount of tensile stress to the substrate may cause a residual strain in the substrate after the coating, due to exceeding an elastic limit thereof, thereby affecting a shape of the resulting product. Alternatively, there may be a case in which the shape of the resulting product is changed with the passing of time or due to an influence of surrounding environment.

Accordingly, an establishment of a technique is desired, in a case in which film formation is carried out by coating or the like, which allows for the coating or the like to be performed without stretching a substrate with a more than necessary amount of stress, and for stably carrying out the film formation.

The present disclosure has been made in view of the above mentioned problems. An object thereof is to provide a method of manufacturing a composite film, which method is capable of stably forming a porous layer having a favorable smoothness, without applying to a porous substrate a tensile stress which causes an elongation of the porous substrate to exceed 2%. The present disclosure aims to achieve this object.

### Means for Solving the Problem

Specific means for solving the above problems include the following aspects.

<1> A method of manufacturing a composite film, the method including:

subjecting a porous substrate containing a thermoplastic resin to a heat treatment (heat treatment process) at a temperature T which satisfies the following Formula;

coating a coating liquid (coating process) containing at least a resin and a solvent on one surface or both surfaces of the porous substrate, which has been subjected to the heat treatment, to form a coating layer, with a tensile stress in a machine direction in the porous substrate adjusted to be within a range in which an elongation of the porous substrate is 2% or less; and solidifying the coating layer to obtain a composite film (solidification process) including the porous substrate and a porous layer containing at least the resin formed on one surface or both surfaces of the porous substrate.

Tg+60° C.≦temperature T≦Tm

Tg: a glass transition temperature (° C.) of the thermoplastic resin contained in the porous substrate

Tm: a melting point (° C.) of the thermoplastic resin contained in the porous substrate

<2> The method of manufacturing a composite film as described in the above <1>, wherein a mean value of a thickness of the porous substrate before being subjected to the heat treatment is from 5 μm to 50 μm.

<3> The method of manufacturing a composite film as described in the above <1> or <2>, wherein a standard deviation of a thickness of the porous substrate before being subjected to the heat treatment is from 0.40 μm to 30 μm.

<4> The method of manufacturing a composite film as described in any one of the above <1> to <3>, wherein a glass transition temperature of the porous substrate before being subjected to the heat treatment is 30° C. or lower.

<5> The method of manufacturing a composite film as described in any one of the above <1> to <4>, wherein solidification process of obtaining a composite film is carried out by bringing the coating layer into contact with a solidifying liquid to solidify the resin, to obtain the composite film including the porous substrate and the porous layer containing at least the resin formed on one surface or both surfaces of the porous substrate.

<6> The method of manufacturing a composite film as described in any one of the above <1> to <5>, wherein the coating liquid further contains a filler, and the porous layer obtained by solidifying the coating layer in the solidification process further contains the filler.

### Effect of the Invention

The present disclosure provides a method of manufacturing a composite film, which method is capable of stably forming a porous layer having a favorable smoothness, without applying to a porous substrate a tensile stress which causes the elongation of the porous substrate to exceed 2%.

### BRIEF DESCRIPTION OF DRAWINGS

FIG. 1 is a schematic diagram showing one embodiment of a manufacturing method according to the present invention.

FIG. 2 is a schematic diagram showing another embodiment of the manufacturing method according to the invention.

FIG. 3 is a schematic diagram illustrating a state of sagging and the like of a porous substrate.

FIG. 4 is a sectional view of the porous substrate shown in FIG. 3, taken along a line A-A′.

### DESCRIPTION OF EMBODIMENTS

In the present specification, any numerical range including an expression “to” therein represents a range in which numerical values described before and after the “to” are included in the range as a maximum value and a minimum value, respectively.

In present specification, the term “process” includes not only an independent process, but also a process which is not clearly distinguishable from another process, as long a desired effect of the process is achieved.

Further, the term “machine direction” refers to a longitudinal direction of a porous substrate and a composite film which are formed in a long length, and the term “width direction” refers to a direction orthogonal to the machine direction of the porous substrate and the composite film. Hereinafter, the “machine direction” is also referred to as “MD”, and the “width direction” is also referred to as “TD”.

The method of manufacturing a composite film according to the present disclosure will now be described in detail.

The method of manufacturing a composite film according to the present disclosure includes at least:

subjecting a porous substrate containing a thermoplastic resin to a heat treatment at a temperature T which satisfies the Formula shown below (hereinafter, referred to as “heat treatment process”);

coating a coating liquid containing at least a resin and a solvent on one surface or both surfaces of the porous substrate which has been subjected to the heat treatment to form a coating layer, with a tensile stress in a machine direction in the porous substrate adjusted to be within a range in which an elongation of the porous substrate is 2% or less (hereinafter, referred to as “coating process”); and

solidifying the coating layer to obtain a composite film including the porous substrate and a porous layer containing at least the resin formed on one surface or both surfaces of the porous substrate (hereinafter, referred to as “solidification process”).

Tg+60° C.≦temperature T≦Tm

In the above Formula, Tg represents a glass transition temperature (° C.) of the thermoplastic resin contained in the porous substrate, and Tm represents a melting point (° C.) of the thermoplastic resin contained in the porous substrate.

The method of manufacturing a composite film according to the present disclosure includes at least the heat treatment process, the coating process and the solidification process. The solidification process may be carried out by either a wet process in which the coating layer is brought into contact with a solidifying liquid to solidify the resin contained in the coating layer to obtain the porous layer, or a dry process in which the solvent contained in the coating layer is removed to solidify the resin contained in the coating layer, thereby obtaining the porous layer. A method utilizing a wet process is preferred.

The method of manufacturing a composite film according to the present disclosure preferably includes removing water in the composite film (hereinafter, referred to as “drying process”). The present method may further include other treatments (processes) such as preparing a coating liquid (hereinafter, referred to as “coating liquid preparation process”); washing the composite film with water after the solidification process (hereinafter, referred to as “water washing process”); and the like, if necessary.

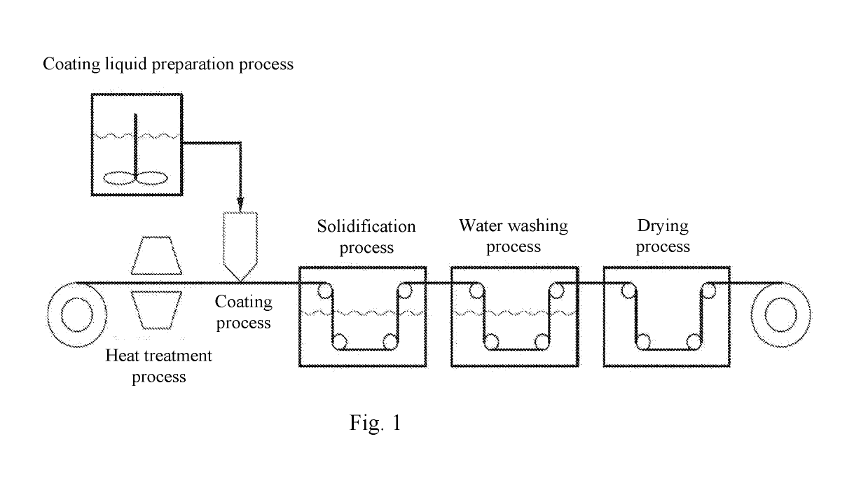

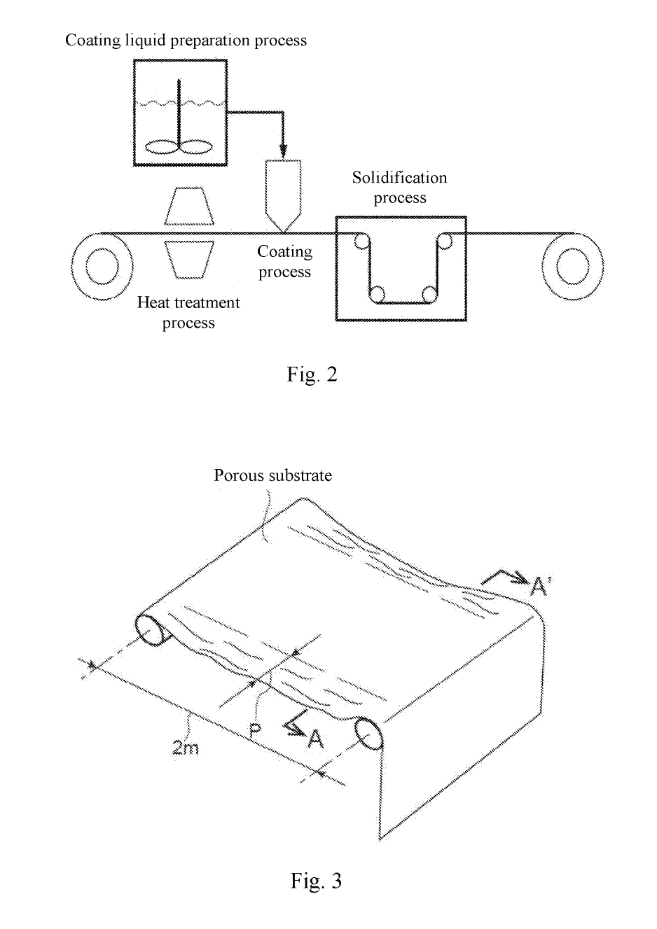

Examples of the respective embodiments of the wet process and the dry process in the method of manufacturing a composite film according to the present disclosure are shown in FIG. 1 and FIG. 2, respectively. Specific details of the respective treatments (processes) in the respective embodiments will be described later.

FIG. 1 shows one embodiment of the method of manufacturing a composite film according to the invention. The embodiment shown in FIG. 1 includes the coating liquid preparation process, the heat treatment process, the coating process, the solidification process, the water washing process, and the drying process. In this embodiment, the solidification process is carried out by the wet process. In FIG. 1, a roll of the porous substrate to be used in the production of the composite film is shown on the left side in the figure, and a roll about which the resulting composite film is to be wound is shown on the right side in the figure. In the present embodiment, the heat treatment process, the coating process, the solidification process, the water washing process, and the drying process are carried out continuously and sequentially. Further, in the present embodiment, the coating liquid preparation process is carried out at a time point suitable for carrying out the coating process.

FIG. 2 shows another embodiment of the method of manufacturing a composite film according to the invention. The embodiment shown in FIG. 2 includes the coating liquid preparation process, the heat treatment process, the coating process, and the solidification process. In this embodiment, the solidification in the solidification process is carried out by the dry process. In FIG. 2, a roll of the porous substrate to be used in the production of the composite film is shown on the left side in the figure, and a roll about which the resulting composite film is to be wound is shown on the right side in the figure. In the present embodiment, the heat treatment process, the coating process, and the solidification process are carried out continuously and sequentially. Further, in the present embodiment, the coating liquid preparation process is carried out at a time point suitable for carrying out the coating process.

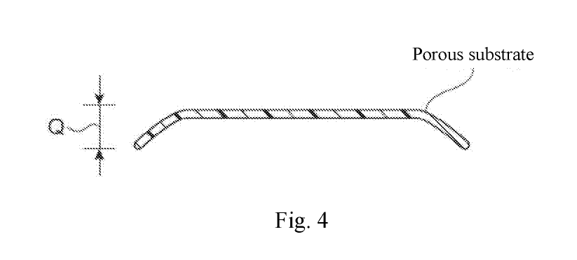

In the present disclosure, the heat treatment process of subjecting the porous substrate to a heat treatment is carried out in advance, before the coating process, so that the coating can be performed without applying a high tensile stress which may cause a residual strain in the porous substrate after the coating. In other words, when forming a coating layer on a porous substrate, conventionally, a method has been used in which a tensile force is applied to the porous substrate in order to form a favorably uniform coating layer. The reason for this is because, the sagging of the porous substrate to be coated, or the irregularities on the surface of the porous substrate or the variation in thickness of the porous substrate is likely to have an adverse effect on the resulting coating layer. The sagging of the porous substrate refers to a sagging which occurs in the form of pleats at end portions in the width direction of the porous substrate, when the porous substrate is stretched between transport rolls. For example, the sagging refers, as shown in FIG. 3, to a deformation in the form of pleats which occurs in an arbitrarily width (“sag width P” in the case shown in FIG. 3) extending from each of the end portions in the width direction toward the inner direction, of the porous substrate. Alternatively, the sagging refers, as shown in FIG. 4, to a deformation which occurs due to the end portions in the width direction of the porous substrate drooping (“droop width Q” in the case shown in FIG. 4) in the direction of gravity, and thus being unable to maintain a desired plane state.

However, when a more than necessary amount of tensile force is applied to the porous substrate, there is a case in which the applied tensile force exceeds the elastic limit of the substrate, and the resulting product after the coating may be deformed due to the residual strain, or alternatively, the product may be deformed with the passing of time or due to the influence of surrounding environment.

In the present disclosure, since the porous substrate before the coating is subjected to a heat treatment in advance, the sagging of the porous substrate, or the surface irregularities or the variation in thickness of the porous substrate is alleviated. At the same time, the residual strain in the porous substrate is reduced (stress-relief effect). This serves to improve the smoothness of the porous substrate to be coated, which in turn allows for a stable production of a composite film including a highly uniform coating layer.

A description will be given below in detail, regarding each of the processes in the method of manufacturing a composite film according to an embodiment of the invention.

### [Heat Treatment Process]

In the heat treatment process, as a pretreatment process of the coating process to be described later, a porous substrate containing a thermoplastic resin is subjected to a heat treatment at a temperature T which satisfies the Formula shown below. By subjecting the porous substrate to a heat treatment, it is possible to obtain an effect of alleviating characteristics of the porous substrate (such as the sagging of the porous substrate, or the surface irregularities or the variation in thickness of the porous substrate) which is required for stably carrying out the coating.

Tg+60° C.≦temperature T≦Tm

In the above Formula, Tg represents the glass transition temperature (° C.) of the thermoplastic resin contained in the porous substrate, and Tm represents the melting point (° C.) of the thermoplastic resin contained in the porous substrate.

As shown in FIG. 1 and FIG. 2, the heat treatment process is carried out before the coating process. The heat treatment process may be carried out in a transport path through which the porous substrate drawn from the roll is transported before being subjected to the coating.

The method of the heat treatment is not particularly limited, and can be selected as appropriate, as long as the method allows for applying heat to the porous substrate at a temperature necessary for the heat treatment for a necessary period of time.

The specific method of the heat treatment is not particularly limited. Examples thereof include a method in which a porous substrate is stored in an oven or a thermostatic chamber controlled at a required temperature, and then the stored porous substrate is the subjected to coating; a method in which a hot air is blown to a porous substrate; a method in which a porous substrate is heated by a radiant heat of an infrared heater; a method in which a porous substrate is exposed to light irradiation by a heat-generating lamp (such as a heat-generating bulb) or a laser light source; a method in which a hot roll or a hot plate is brought into contact with a porous substrate to impart heat to the substrate; and a method in which a microwave is irradiated to a porous substrate.

The heat treatment can be carried out by providing a heating apparatuses in the transport path before the coating process. In this case, the heat treatment may be performed on either one surface or the other surface of the porous substrate being transported at a predetermined transport speed, or on both the one surface and the other surface of the porous substrate. For example, as shown in FIG. 1 and FIG. 2, when the heat treatment is performed by applying heat from both sides of the porous substrate being transported through the transport path, it is possible to uniformly heat the entire surfaces of the porous substrate.

The temperature T in the above Formula is a surface temperature of the porous substrate. The temperature T can be obtained by a method, for example, in which the surface temperature is measured by bringing a thermocouple into contact with the surface of the porous substrate, or a method in which the surface temperature is measured by an infrared temperature measurement device utilizing infrared light, or the like, without contacting the surface of the porous substrate.

The glass transition temperature (Tg) of the thermoplastic resin is a value measured using a differential scanning calorimeter (DSC; Q-200, manufactured by TA Instruments Inc.) under the following conditions. Tg is defined as an intermediate temperature (rounded to an integer), which corresponds to a midpoint between a start point and an end point of the fall of the temperature in a DSC curve.

### <Conditions>

Measurement chamber: nitrogen atmosphere
Temperature rise rate: 5° C./min
Temperature at the start of the measurement: −50° C.
Temperature at the end of the measurement: 200° C.
Amount of sample: 5 mg

The melting point (Tm) is also a value measured by the same differential scanning calorimeter (DSC) as described above, under the same conditions.

The heat treatment is carried out such that the temperature T is “Tg+60° C.” or more. When the temperature T is less than “Tg+60° C.”, it results in an insufficient effect of alleviating the characteristics of the porous substrate (such as the sagging of the porous substrate, or the surface irregularities or the variation in thickness of the porous substrate) is provided by applying heat to the substrate. Further, the temperature T during the heat treatment is controlled to be equal to or less than the melting point Tm of the thermoplastic resin. When the temperature T during the heat treatment is higher than the melting point Tm, the porous substrate is softened and it becomes difficult to maintain the shape of the substrate, and the uniformity of the porous substrate is instead deteriorated. As a result, coating quality tends to decrease.

For the same reason as described above, the temperature T during the heat treatment is preferably within a temperature range which satisfies the following Formula (1) or Formula (2):

Tg+60° C.≦temperature T≦Tm−20° C. (1)

Tg+80° C.≦temperature T≦Tm−40° C. (2).

The period of time for carrying out the heat treatment is not particularly limited, and can be selected as appropriate depending on the temperature at which the heat treatment is carried out, in terms of further improving coating performance. For example, the period of time for carrying out the heat treatment is preferably from 0.01 seconds to 30 seconds, and more preferably from 0.1 seconds to 5 seconds.

It is preferable that the tensile stress in the machine direction (MD) in the porous substrate during the heat treatment is adjusted within a range in which the elongation of the porous substrate is 2% or less. In other words, the tensile stress to be applied to the porous substrate during the heat treatment is preferably reduced within a certain range in which the porous substrate can be stretched up to 2% in the MD. In the manufacturing method according to the present disclosure, since the tensile stress in the MD is reduced within a range in which the elongation of the porous substrate is 2% or less, as described later, it is possible to prevent the strain applied to the composite film from remaining therein.

Specifically, it is preferable that the tensile stress in the MD is from 0.1 N/cm to 3 N/cm, and more preferably from 0.5 N/cm to 2 N/cm.

The tensile stress in the porous substrate is measured by subjecting the porous substrate to a tensile test, using a tensile tester, under an atmosphere of 20° C. at a tensile speed of 100 mm/min.

Further, as a pretreatment process before carrying out the heat treatment, a plurality of the porous substrates formed in a long length may be drawn while connecting the respective porous substrates with an adhesive agent or a double sided adhesive tape, or by thermal fusion bonding, so that the porous substrate formed in a long length can be continuously drawn to be subjected to the heat treatment process. In this case, substances may be attached to the surfaces of the connected porous substrates, due to the connecting. Accordingly, an apparatus for removing the attached substances is also used, if necessary, such as one utilizing a low adhesion roll, a suction roll, or an air sprayer. Further, an apparatus for removing static electricity is also used, since there is a case in which the porous substrate is charged with static electricity to cause surrounding floating substances to adhere thereto, depending on a material of the porous substrate. In addition, in order to further enhance the effect of the heat treatment, it is preferable to provide an apparatus for stretching wrinkles (waviness) of the porous substrate, such as an expander roll or a helical roll.

[Coating Process]

In the coating process, a coating liquid containing at least a resin and a solvent (and preferably a filler) is coated on one surface or both surfaces of the porous substrate which has been subjected to the heat treatment, with the tensile stress in the machine direction in the porous substrate adjusted to be within a range in which the elongation of the porous substrate is 2% or less, thereby forming a coating layer. This allows for forming a highly uniform coating layer, since the coating of the coating liquid is performed on the porous substrate in which the sagging, the surface irregularities, or the variation in thickness is alleviated, and in which the residual strain is reduced at the same time, due to being subjected to the above described heat treatment process.

The coating of the coating liquid on the porous substrate may be performed using a conventional coating apparatus such as a Meyer bar, a die coater, a reverse roll coater, or a gravure coater. In a case in which the porous layer is formed on both surfaces of the porous substrate, it is preferable that the coating liquid is coated simultaneously on both surfaces of the substrate, in terms of productivity.

The coating is carried out while stretching the porous substrate in the MD. At this time, the tensile stress in the machine direction in the porous substrate is adjusted within a range in which the elongation of the porous substrate is 2% or less (102% or less of the length of the substrate without stretching). In other words, the coating can be performed in a state where the tensile stress in the machine direction in the porous substrate is reduced. That is to say, it is not necessary to stretch the porous substrate in the machine direction with a stress capable of eliminating the characteristics of the porous substrate, such as the sagging of the porous substrate, or the surface irregularities or the variation in thickness of the porous substrate, and to maintain the stress while carrying out the coating, as has been conventionally carried out, in order to eliminate unevenness in the coating layer which is likely to occur due to the above described characteristics.

The elongation of the porous substrate is measured using a tensile tester (TENSILON RTC-1225A), manufactured by A&D Company, Limited.

The coating liquid may be coated, for example, in a total amount for both surfaces of from 10 mL/m² to 60 mL/m².

The transport speed of the porous substrate in the coating process can be preferably within the range of from 10 m/min to 100 m/min, since production efficiency and coating stability can be easily secured due to carrying out the heat treatment process.

[Coating Liquid Preparation Process]

In the method of manufacturing a composite film according to the present disclosure, a coating liquid which has been stored or a ready-made coating liquid such as a commercially available coating liquid may be used. Alternatively, a coating liquid prepared specifically for the coating may also be used. In the case of the latter, it is possible to carry out a coating liquid preparation process, in which a coating liquid containing at least a resin and a solvent is prepared, as the coating liquid to be coated in the above described coating process. The coating liquid may be: a coating liquid containing a filler, a resin, and a solvent; a coating liquid containing a resin and a solvent; or a water-based emulsion containing a resin and a solvent.

The coating liquid is prepared, for example, by dissolving a resin in a solvent, or alternatively, by dissolving a resin in a solvent, followed by further dispersing a filler in the resultant.

The details regarding the resin and the filler used in the preparation of the coating liquid, namely, the resin and the filler contained in the porous layer, will be described in the section of “Porous Layer” to be described later.

As the solvent to be used for dissolving the resin in the preparation of the coating liquid (hereinafter, also referred to as “good solvent”), a polar amide solvent such as N-methylpyrrolidone, dimethylacetamide, dimethylformamide, dimethylformamide, or the like is suitably used.

In terms of forming a porous layer having a favorable porous structure, it is preferable to add and mix a phase separating agent for inducing phase separation, in addition to the good solvent. Examples of the phase separating agent include water, methanol, ethanol, propyl alcohol, butyl alcohol, butanediol, ethylene glycol, propylene glycol, and tripropylene glycol. It is preferable that the phase separating agent is added and mixed with the good solvent to the extent that the resulting coating liquid has a viscosity suitable for the coating.

The solvent to be used in the preparation of the coating liquid is preferably a mixed solvent containing 60% by mass or more of the good solvent, and from 10% by mass to 40% by mass of the phase separating agent, in terms of forming a favorable porous structure.

It is preferable that the coating liquid contains a resin in a concentration of from 3% by mass to 10% by mass, and contains a filler in a concentration of from 10% by mass to 90% by mass, in terms of forming a favorable porous structure.

The coating liquid prepared in the coating liquid preparation process preferably has a viscosity at 25° C. of from 0.1 Pa·s to 5.0 Pa·s. When the coating liquid has a viscosity of 0.1 Pa·s or more, it is possible to obtain a coating suitability to the porous substrate, and at the same time, to further enhance the effect provided during the coating by the method of manufacturing a composite film according to the present disclosure. When the coating liquid has a viscosity of 5.0 Pa·s or less, on the other hand, it is possible to supply the coating liquid more stably.

The coating liquid more preferably has a viscosity (at 25° C.) of 1.0 Pa·s or more, and still more preferably 2.0 Pa·s or more. At the same time, the coating liquid more preferably has a viscosity (at 25° C.) of 4.0 Pa·s or less, and still more preferably 3.0 Pa·s or less.

The viscosity of the coating liquid can be controlled by adjusting a composition ratio of the solvent, the resin and the filler.

The viscosity as used herein refers to a value as measured by a rotational viscosity meter (Type B viscosity meter, manufactured by EKO Instruments Co., Ltd.) in a state where the temperature of the coating liquid is controlled at 25° C.

[Solidification Process]

In the solidification process, the coating layer formed in the coating process is solidified, to obtain a composite film including the porous substrate and a porous layer containing at least the resin formed on one surface or both surfaces of the porous substrate.

The solidification process may be carried out by either a wet process in which the coating layer is brought into contact with a solidifying liquid to solidify the resin contained in the coating layer, thereby obtaining the porous layer, or a dry process in which the solvent contained in the coating layer is removed to solidify the resin contained in the coating layer, thereby obtaining the porous layer. The dry process is advantageous in terms of production process, since the dry process does not require bringing the coating layer into contact with a solidifying liquid and washing the layer with water, which are required in the wet process. However, the porous layer formed by the dry process tends to be denser as compared to that formed by the wet process. Accordingly, the wet process is preferably used in the present disclosure, in terms of obtaining a favorable porous structure.

In the wet process, the porous substrate having the coating layer is preferably immersed in a solidifying liquid. Specifically, the porous substrate is preferably passed through a tank (solidification tank) containing a solidifying liquid.

The solidifying liquid to be used in the wet process is generally prepared from the good solvent and the phase separating agent used in the preparation of the coating liquid, and water. A mixing ratio of the good solvent and the phase separating agent is preferably the same as the mixing ratio of the mixed solvent used in the preparation of the coating liquid, in terms of production. A suitable concentration of water is within a range of from 40% by mass to 80% by mass with respect to the total amount of the solidifying liquid, in terms of formability of the porous structure and productivity. The temperature of the solidifying liquid may be, for example, from 20° C. to 50° C.

In the dry process, the method of removing the solvent from the composite film is not particularly limited. Examples thereof include a method in which the composite film is brought into contact with a heat-generating member; and a method in which the composite film is transported into a chamber controlled at a certain temperature and humidity. In a case in which heat is applied to the composite film, the temperature of the heat is, for example, from 50° C. to 80° C.

[Water Washing Process]

The method of manufacturing a composite film according to the present disclosure preferably includes a water washing process of washing the composite film with water after the solidification process, in a case in which the wet process is used as the solidification process. In the water washing process, the solvents (the solvent used in the coating liquid and the solvent used in the solidifying liquid) contained in the composite film are removed.

The water washing process may be carried out by transporting the composite film through a water bath. The temperature of the water for washing is, for example, from 0° C. to 70° C.

[Drying Process]

The method of manufacturing a composite film according to the present disclosure preferably includes a drying process of removing water from the composite film after the water washing process. The method of drying is not particularly limited. Examples thereof include a method in which the composite film is brought into contact with a heat-generating member; and a method in which the composite film is transported into a chamber controlled at a certain temperature and humidity.

In a case in which heat is applied to the composite film, the temperature of the heat is, for example, from 50° C. to 80° C.

Next, the porous substrate and the porous layer constituting the composite film will be described in detail.

### [Porous Substrate]

The porous substrate refers to a substrate which includes pores or cavities in the interior thereof. Examples of such a substrate include a microporous film; a porous sheet composed of a fibrous product such as a nonwoven fabric or a paper; and a composite porous sheet obtained by layering one or more other porous layers on the microporous film or the porous sheet as described above.

In the present disclosure, a microporous film is preferred, in terms of obtaining a thinner and stronger composite film. The microporous film refers to a film which includes a number of micropores in the interior thereof, and has a structure in which these micropores are connected, so that a gas or a liquid is able to pass therethrough from one surface to the other surface of the film.

A material as a component of the porous substrate is preferably a material having an electrical insulating property, and may be either an organic material or an inorganic material.

The material as a component of the porous substrate is preferably a thermoplastic resin, in terms of imparting a shutdown function to the porous substrate. The shutdown function refers to a function, in a case in which the composite film is used as a battery separator, in which the component material is melted to clog the pores of the porous substrate, when the temperature of the battery is increased, thereby blocking ion migration and preventing a thermal run away of the battery.

The thermoplastic resin is suitably a thermoplastic resin having a melting point of less than 200° C., and particularly preferably a polyolefin.

The porous substrate is preferably a microporous film containing a polyolefin (hereinafter, also referred to as “polyolefin microporous film). Examples of the polyolefin microporous film include polyolefin microporous films used in conventional battery separators. Among these, one having favorable mechanical properties and substance permeability can be selected.

The polyolefin microporous film preferably contains one or both of polyethylene and propylene, in terms of providing the shutdown function. In particular, the polyolefin microporous film preferably contains polyethylene, from the same viewpoint as descried above. Further, the polyolefin microporous film is preferably a polyethylene microporous film having a polyethylene content of 95% by mass or more.

The polyolefin microporous film is preferably a polyolefin microporous film containing polyethylene and polypropylene, since such a film has a heat resistance sufficient for preventing the film from easily rupturing when exposed to a high temperature. Examples of the polyolefin microporous film as described above include a microporous film in which polyethylene and polypropylene coexist within one layer. The microporous film as described above is preferably a polyolefin microporous film containing 95% by mass or more of polyethylene and 5% by mass or less of polypropylene, in terms of obtaining both the shutdown function and the heat resistance in a balanced manner. Further, in terms of obtaining both the shutdown function and the heat resistance in a balanced manner, the microporous film is preferably a polyolefin microporous film having a laminated structure composed of two or more layers, in which at least one layer contains polyethylene and at least one layer contains polypropylene.

The polyolefin included in the polyolefin microporous film suitably has a weight-average molecular weight of from 100,000 to 5,000,000. When the polyolefin has a weight-average molecular weight of greater than 100,000, favorable mechanical properties can be secured. When the polyolefin has a weight-average molecular weight of less than 5,000,000, on the other hand, the resulting film has a favorable shut down property, and the film formation can be carried out easily.

The polyolefin microporous film can be manufactured, for example, by the methods described below. The methods are specifically as follows.

A first method is a method in which a melted polyolefin resin is extruded from a T-die to be formed into a sheet. The resultant is subjected to a crystallization treatment, followed by stretching, and then further subjected to a heat treatment, thereby obtaining a microporous film. A second method is a method in which a polyolefin resin melted along with a plasticizer, such as liquid paraffin, is extruded from a T-die, and the resultant is cooled to be formed into a sheet. After stretching the resulting sheet, the plasticizer is extracted therefrom, and the resultant is subjected to a heat treatment, thereby obtaining a microporous film.

Examples of the porous sheet composed of a fibrous product include porous sheets, such as nonwoven fabrics and papers, composed of fibrous products such as polyesters such as polyethylene terephthalate; polyolefins such as polyethylene and polypropylene; heat resistant resins such as aromatic polyamides, polyimides, polyethersulfones, polysulfones, polyether ketones, and polyetherimides; and celluloses.

The heat resistant resin refers to a resin having a melting point of 200° C. or higher, or a resin which does not have a melting point and has a decomposition temperature of 200° C. or higher.

The composite porous sheet may have a structure in which a functional layer(s) is/are layered on a porous sheet composed of a microporous film or a fibrous product. Such a composite porous sheet is preferred, because the functional layer(s) included therein allow(s) for imparting an additional function(s). In terms of imparting heat resistance, for example, a porous layer composed of a heat resistant resin, or a porous layer composed of a heat resistant resin and an inorganic filler can be used as the functional layer. The heat resistant resin may be, for example, one kind or two or more kinds of heat resistant resins selected from aromatic polyamides, polyimides, polyethersulfones, polysulfones, polyether ketones or polyetherimides. As the inorganic filler, a metal oxide such as an alumina; a metal hydroxide such as magnesium hydroxide; or the like can be suitably used. The method of forming the composite film may include, for example, a method in which a functional layer is coated on a microporous film or a porous sheet; a method in which a microporous film or a porous sheet and a functional layer are bonded with an adhesive agent; and a method in which a microporous film or a porous sheet and a functional layer are bonded by thermocompression bonding.

The glass transition temperature (namely, the glass transition temperature before being subjected to the heat treatment) of the thermoplastic resin is preferably within the range of 30° C. or lower, more preferably within the range of 0° C. or lower, and still more preferably within the range of −10° C. or lower. When the glass transition temperature is 30° C. or lower, it is possible to easily carry out the heat treatment. At the same time, the glass transition temperature is preferably within the range of −50° C. or higher, and more preferably within the range of −30° C. or higher, in terms of productivity.

The porous substrate is preferably a long length product having a width of from 0.1 m to 3.0 m, in terms of compatibility with the manufacturing method according to the present disclosure.

It is preferable that a mean value of the thickness (namely, the mean value of the thickness before being subjected to the heat treatment) of the porous substrate is within the range of from 5 μm to 50 μm, more preferably within the range of from 5 μm to 30 μm, and still more preferably within the range of from 5 μm to 20 μm, in terms of mechanical strength.

The thickness of the porous substrate is obtained by measuring the thickness at arbitrary 20 points within an area of 10 cm×30 cm in the porous substrate, using a contact type thickness meter (LITEMATIC; manufactured by Mitutoyo Corporation), and by calculating the mean value of the measured values. The measurement is carried out using a measuring terminal in the form of a cylinder having a diameter of 5 mm, with a load applied during the measurement being adjusted to 7 g.

Further, it is preferable that a standard deviation of the thickness (namely, the standard deviation of the thickness before being subjected to the heat treatment) of the porous substrate is within the range of from 0.35 μm to 30 μm, more preferably within the range of from 0.40 μm to 30 μm, still more preferably within the range of from 0.45 μm to 20 μm, still more preferably within the range of from 0.45 μm to 5 μm, and still more preferably within the range of from 0.45 μm to 1 μm. According to the manufacturing method of the present disclosure, it is possible to achieve both an improvement in the coating quality and a reduction in internal stress in a balanced manner, even in the case of using such a porous substrate having a relatively large variation in thickness.

The standard deviation of the thickness is calculated from the measured values of the thickness of the porous substrate obtained as described above.

The porous substrate preferably has a Gurley value (JIS P8117 (2009)) of 50 sec/100 cc to 800 sec/100 cc, in terms of the mechanical strength and the substance permeability.

The porous substrate preferably has a porosity of 20% to 60%, in terms of the mechanical strength, handleability, and the substance permeability.

The porous substrate preferably has an average pore diameter of from 20 nm to 100 nm, in terms of the substance permeability. The average pore diameter as used herein refers to a value measured using a PALM POROMETER, in accordance with ASTM E1294-89.

[Porous Layer]

The porous layer refers to a layer which includes a number of micropores in the interior thereof, and has a structure in which these micropores are connected, so that a gas or a liquid is able to pass therethrough from one surface to the other surface of the film.

In a case in which the composite film is used as a battery separator, the porous layer is preferably an adhesive porous layer capable of adhering to an electrode. The adhesive porous layer may be provided on only one surface of the porous substrate. However, it is more preferable that the adhesive porous layer is provided on both surfaces of the porous substrate.

The porous layer is formed by coating a coating liquid containing a filler, a resin and a solvent; a coating liquid containing a resin and a solvent; or a water-based emulsion containing a resin and a solvent. Accordingly, the porous layer contains a resin and a filler, or contains a resin.

A description will now be given below regarding the porous layer, and the components such as a resin contained in the coating liquid to be used in the formation of the porous layer.

(Resin)

The type of the resin to be contained in the porous layer is not limited. The resin to be contained in the porous layer is preferably a resin (so-called binder resin) having a function to bind particles of a filler. In a case in which the composite film is used as a battery separator, the resin to be contained in the porous layer is preferably a resin which is stable in an electrolyte solution, which is electrochemically stable, which has a function of binding inorganic particles, and which is capable of adhering to an electrode. In a case in which the composite film is prepared by the wet process, the resin to be contained in the porous layer is preferably a hydrophobic resin, in terms of production compatibility.

The porous layer may contain one kind of resin, or two or more kinds of resins.

For example, the resin is preferably polyvinylidene fluoride, a polyvinylidene fluoride copolymer, a styrene-butadiene copolymer, a homopolymer or a copolymer of a vinyl nitrile such as acrylonitrile or methacrylonitrile, or a polyether such as polyethylene oxide or polypropylene oxide. Of these, polyvinylidene fluoride and a polyvinylidene fluoride copolymer (also collectively referred to as a polyvinylidene fluoride resin) are particularly preferred.

Examples of the polyvinylidene fluoride resin include a homopolymer of vinylidene fluoride (namely, polyvinylidene fluoride), a copolymer of vinylidene fluoride and another monomer copolymerizable with vinylidene fluoride (namely, a polyvinylidene fluoride copolymer), and any mixture of these resins.

Examples of the monomer copolymerizable with vinylidene fluoride include tetrafluoroethylene, hexafluoropropylene, trifluoroethylene, trichloroethylene, and vinyl fluoride. One kind or two or more kinds of these monomers can be used.

The polyvinylidene fluoride resin can be obtained by emulsion polymerization or suspension polymerization.

The resin to be contained in the porous layer is preferably a heat resistant resin (a resin having a melting point of 200° C. or higher, or a resin which does not have a melting point and has a decomposition temperature of 200° C. or higher), in terms of heat resistance.

Examples of the heat resistant resin include polyamides (Nylons), wholly aromatic polyamides (aramids), polyimides, polyamideimides, polysulfones, polyketones, polyether ketones, polyether sulfones, polyetherimides, celluloses, and any mixture of these resins. Among these, a wholly aromatic polyamide is preferred, in terms of ease of forming a porous structure, ability to bind to inorganic particles, and oxidation resistance. Among the wholly aromatic polyamides, a meta-type wholly aromatic polyamide is preferred, and polymetaphenylene isophthalamide is particularly suitable, in terms of ease of molding.

As the resin to be used in the method of manufacturing a composite film according to the embodiment of the invention, a resin in the form of particles or a water soluble resin can be used, if appropriate, in addition to those described above. The resin in the form of particles may be, for example, resin particles containing a resin such as a polyvinylidene fluoride resin, a fluorine rubber, or a styrene-butadiene rubber. The resin particles can be used by dispersing the resin particles in a dispersion medium such as water, thereby preparing a coating liquid. The water soluble resin may be, for example a cellulose resin or a polyvinyl alcohol. In this case, water can be used as a solvent. The above described resin in the form of particles and the water soluble resin are suitable in a case in which the solidification process is carried out by the dry process.

(Filler)

The type of the filler to be contained in the porous layer is not limited, and the filler may be either an inorganic filler or an organic filler. The filler is preferably particles in which primary particles have a volume average particle size of from 0.01 μm to 10 μm. When the volume average particle size of the filler is within the above described range, it is possible to improve slippage during the production process, thereby increasing a yield. At the same time, a favorable balance between properties can be obtained, such that both the adhesion to an electrode and the retention of an electrolyte solution are satisfied. The volume average particle size of the filler is more preferably from 0.1 μm to 10 μm, and still more preferably from 0.1 μm to 3.0 μm.

The volume average particle size of the filler refers to a value measured using a laser diffraction particle size distribution measuring apparatus.

The filler is preferably inorganic particles, in terms of porosifying the porous layer and of heat resistance. The inorganic particle to be contained in the porous layer is preferably particles which are stable in an electrolyte solution, and at the same time, electrochemically stable. The porous layer may contain one kind of inorganic particles, or two or more kinds thereof.

Examples of the inorganic particles include metal hydroxides such as aluminum hydroxide, magnesium hydroxide, calcium hydroxide, chromium hydroxide, zirconium hydroxide, cerium hydroxide, nickel hydroxide, and boron hydroxide; metal oxides such as silica, alumina, zirconia, and magnesium oxide; carbonates such as calcium carbonate, and magnesium carbonate; sulfates such as barium sulfate, and calcium sulfate; and clay minerals such as calcium silicate, and talc. Among these, a metal hydroxide and a metal oxide are preferred, in terms of imparting flame retardancy or of a destaticizing effect. The inorganic particles may be particles which have been surface modified by a silane coupling agent or the like.

The inorganic particles may have an arbitrary shape, and may be in the shape of any of spheres, ellipsoids, plates, and rods, or may be amorphous. It is preferable that the primary particles of the inorganic particles have a volume average particle size of from 0.01 μm to 10 μm, more preferably from 0.1 μm to 10 μm, and still more preferably from 0.1 μm to 3.0 μm, in terms of moldability of the porous layer, the substance permeability of the composite film, and the slippage of the composite film.

In a case in which the porous layer contains inorganic particles, the ratio of the inorganic particles with respect to the total amount of the resin and the inorganic particles is, for example, from 30% by volume to 90% by volume.

The porous layer may contain an organic filler as a filler. Examples of the organic filler include particles composed of crosslinked polymers such as crosslinked poly(meth)acrylic acids, crosslinked poly(meth) acid esters, crosslinked polysilicones, crosslinked polystyrenes, crosslinked polydivinylbenzenes, crosslinked products of styrene-divinylbenzene copolymers, polyimides, melamine resins, phenol resins, and benzoguanamine-formaldehyde condensation products; and particles composed of heat resistant resins such as polysulfones, polyacrylonitriles, aramids, polyacetals, and thermoplastic polyimides.

—Physical Properties of Porous Layer—

The porous layer preferably has a thickness, on one surface of the porous substrate, of from 0.5 μm to 5 μm, in terms of the mechanical strength.

The porous layer preferably has a porosity of from 30% to 80%, in terms of the mechanical strength, the handleability, and the substance permeability.

The porous layer preferably has a pore diameter of from 20 nm to 100 nm, in terms of the substance permeability. The average pore diameter as used herein refers to a value measured using a PALM POROMETER, in accordance with ASTM E1294-89.

[Composite Film]

The method of manufacturing a composite film according to the present disclosure allows for producing a composite film which includes the porous substrate containing a thermoplastic resin and the porous layer formed on the porous substrate.

The composite film can be formed to have a thickness of from 5 μm to 100 μm, for example. When used as a battery separator, the composite film can be formed to have a thickness of from 5 μm to 50 μm, for example.

The composite film preferably has a Gurley value (JIS P8117 (2009)) of from 50 sec/100 cc to 800 sec/100 cc, in terms of the mechanical strength and the substance permeability.

The composite film preferably has a porosity of from 30% to 60%, in terms of the mechanical strength, the handleability, and the substance permeability.

The composite film can be used, for example, as a battery separator, a film for a condenser, a gas filter, a liquid filter, or the like. In particular, the composite film in the present disclosure is particularly suitably used as a non-aqueous secondary battery separator.

### EXAMPLES

One embodiment of the present invention will now be specifically described with reference to Examples. Note, however, that the method of manufacturing a composite film according to one embodiment of the invention is not limited to the following Examples, as long as the gist of the invention is not deviated.

(Evaluation and Measurement Methods)

The following measurement and evaluation were carried out for each of the separators and lithium ion secondary batteries prepared in Examples and Comparative Examples described below. The results of the measurement and the evaluation are shown in the following Table 1.

—Thickness of Porous Substrate—

The thickness of the porous substrate was measured at arbitrary 20 points within an area of 10 cm×30 cm in the substrate, using a contact type thickness meter (LITEMATIC; manufactured by Mitutoyo Corporation), and the mean value and the standard deviation of the thickness were calculated based on the measured values. The measurement was performed using a measuring terminal in the form of a cylinder having a diameter of 5 mm, with the load applied during the measurement being adjusted to 7 g.

—Viscosity of Coating Liquid—

The viscosity (Pa·s) at 25° C. of the coating liquid was measured, using a rotational viscosity meter (Type B viscosity meter, manufactured by EKO Instruments Co., Ltd.).

—Deflection of Porous Substrate—

As the deflection of the porous substrate, the sag width from each of both ends of the substrate in the width direction, and the difference in height (droop width) between the film surface and the end portions of the substrate in the width direction drooping in the direction of gravity, were measured according to the following methods.

### (1) Sag Width

As shown in FIG. 3, a polyethylene microporous film was set between two support rolls which are disposed 2 m apart from each other in the transport path, in a state where the film is stretched at a constant tensile force (corresponding to the elongation of the substrate during the coating in each of the Examples and Comparative Examples). Subsequently, the width of the sagging area (sag width P) from each of the end portions in the width direction of the microporous film was measured.

### (2) Droop Width

As shown in FIG. 3 and FIG. 4, a polyethylene microporous film was set between two support rolls which are disposed 2 m apart from each other in the transport path, in a state where the film is stretched at a constant tensile force (corresponding to the elongation of the substrate during the coating in each of the Examples and Comparative Examples). Subsequently, the distance from a predetermined height to the film surface (at an area without sagging), and the distance from the predetermined height to the end portions of the film drooping in the direction of gravity, were measured, and the difference between the distances (droop width Q) was calculated.

—Tg of Thermoplastic Resin—

The glass transition temperature (Tg) of the thermoplastic resin contained in the porous substrate was measured using a differential scanning calorimeter (DSC; Q-200, manufactured by TA Instruments Inc.), under the following conditions. Tg was obtained by determining the intermediate temperature, which corresponds to the midpoint between the start point and the end point of the fall of the temperature in the DSC curve, and rounding the intermediate temperature to an integer.

### <Conditions>

Measurement chamber: nitrogen atmosphere
Temperature rise rate: 5° C./min
Temperature at the start of the measurement: −50° C.
Temperature at the end of the measurement: 200° C.
Amount of sample: 5 mg

—Tm of Thermoplastic Resin—

The melting point (Tm) of the thermoplastic resin contained in the porous substrate was measured using a differential scanning calorimeter (DSC; Q-200, manufactured by TA Instruments Inc.), under the same conditions as described above.

### Example 1

—Coating Liquid Preparation Process—

Polymetaphenylene isophthalamide was dissolved in a mixed solvent of dimethylacetamide and tripropylene glycol, and aluminum hydroxide (inorganic filler; volume average particle size of the primary particles: 0.8 μm) was dispersed in the resulting solution, to prepare a coating liquid.

The composition of the coating liquid in a mass ratio was as follows: aluminum hydroxide:polymetaphenylene isophthalamide:dimethylacetamide:tripropylene glycol=16:4:40:40.

—Heat Treatment Process—

As the porous substrate, a long-length polyethylene microporous film (Gurley value: 200 seconds/100 mL, porosity: 50%) formed using a polyethylene (thermoplastic resin; glass transition temperature (Tg): −20° C.; melting point (Tm): 135° C.), and having a thickness (mean value) of 16 μm and a width of 450 mm was prepared.

In the polyethylene microporous film which had been drawn from an unwinding roll and transported through the transport path, as shown in FIG. 3 and FIG. 4, each sag width P from each of both ends in the width direction was 95 mm, and the difference in height between the film surface and the end portions of the film in the width direction drooping in the direction of gravity (droop width Q) was 17 mm. The sag width and the droop width were measured according to the above described methods.

The above described polyethylene microporous film was brought into contact with a hot plate controlled at 60° C. for 1.2 seconds, thereby carrying out the heat treatment.

—Coating Process—

The polyethylene microporous film which had been subjected to the heat treatment was transported, while gradually applying a tensile force thereto, to the position at which a coating apparatus is disposed. When the tensile force applied to the polyethylene microporous film reached 9N (Newton), the sagging at the end portions of the film in the width direction disappeared. The elongation of the polyethylene microporous film at this time was 0.1%.

While applying a tensile stress (=9N) to the polyethylene microporous film to stretch the film to an elongation of 0.1%, the coating liquid prepared above was coated by a die coater on one surface of the polyethylene microporous film, to form a coating layer having a thickness of 3 μm. The transport speed of the polyethylene microporous film during the coating process was 10 m/min.

—Solidification Process—

The polyethylene microporous film on the surface of which the coating layer had been formed was transported to a solidification tank, and immersed in a solidifying liquid (water:dimethylacetamide:tripropylene glycol=43:40:17 [mass ratio], liquid temperature: 30° C.) contained in the solidification tank to solidify the coating layer, thereby obtaining a composite film.

—Water Washing Process and Drying Process—

Subsequently, the composite film was transported to a water tank, and washed with water by being passed through a water bath which is contained in the water tank and controlled at a temperature of 30° C. Subsequently, the washed composite film was dried by being passed through a drying apparatus.

Each of the above described processes were carried out continuously to prepare a composite film including the polyethylene microporous film and a porous layer formed on one surface of the polyethylene microporous film.

—Evaluation—

The following evaluations were carried out for the resulting composite film. The evaluation results are shown in the following Table 1.

—1. Coating Quality—

The thickness in the width direction of the coating layer coated on the porous substrate was measured at 12 points, and then the mean value of the measured values was calculated. And, the state of the surface of the coating layer was visually observed. Then the evaluation of the coating layer was carried out according to the following evaluation standards.

### <Evaluation Standards>

A: The coating layer was formed on the entire surface of the porous substrate, and the differences between the measured values and the mean value of the film thickness were less than 0.2 μm.
B: The coating layer was formed on the entire surface of the porous substrate, and the differences between the measured values and the mean value of the film thickness were within the range of from 0.2 μm to 1 μm.
C: Some portions of the porous substrate remained uncoated, and the differences between the measured values and the mean value of the film thickness were greater than 1 μm.

—2. Internal Stress—

A coating layer having a predetermined size was cut out from the resulting composite film. After a certain period of time, rates of dimensional change in the MD direction and the TD direction were calculated to obtain the internal stress, and the evaluation of the coating layer was carried out according to the following evaluation standards.

### <Evaluation Standards>

A: The internal stress was less than 0.1% and no wave-like deformation was observed in the composite film.
B: The internal stress was from 0.2% to 0.4% and some wave-like deformation was observed in the composite film.
C: The internal stress was greater than 0.4% or more and significant wave-like deformations were observed in the composite film.

### Examples 2 to 7, and Example 9

The respective processes were carried out continuously to prepare a composite film including the polyethylene microporous film and a porous layer formed on one surface of the polyethylene microporous film in the same manner as in Example 1, except that the properties of the porous substrate, the conditions for carrying out the heat treatment process, and the tensile stress and the elongation of the substrate during the coating, in Example 1, were changed to those shown in Table 1. In Example 9, a long-length polypropylene microporous film (Gurley value: 200 sec/100 mL, porosity: 50%) formed using polypropylene (thermoplastic resin) and having a thickness of 18 μm (mean value) and a width of 450 mm was used as the porous substrate.

Further, evaluations were carried out in the same manner as in Example 1. The evaluation results are shown in Table 1.

### Example 8

The respective processes were carried out continuously to prepare a composite film including the polyethylene microporous film and a porous layer formed on one surface of the polyethylene microporous film in the same manner as in Example 1, except that polyvinylidene fluoride (PVDF) was used as a polymer instead of polymetaphenylene isophthalamide, in the coating liquid preparation process. Further, evaluations were carried out in the same manner as in Example 1. The evaluation results are shown in Table 1.

### Comparative Examples 1 to 6

The respective processes were carried out continuously to prepare a composite film including the polyethylene microporous film and a porous layer formed on one surface of the polyethylene microporous film in the same manner as in Example 1, except that the conditions for carrying out the heat treatment process and the elongation of the substrate during the coating were changed to those shown in Table 1. Further, evaluations were carried out in the same manner as in Example 1. The evaluation results are shown in Table 1.

TABLE 1

| | | Porous substrate (before heat treatment) | | | | | |
|---|---|---|---|---|---|---|---|
| | | | | | | | Standard |
| | | | Glass | | Melting | Mean | deviation |
| | Coating | | transition | Tg + | point | value of | of |
| | layer | | temperature: | 60 | Tm | thickness | thickness |
| | Resin | Type | Tg [° C.] | [° C.] | [° C.] | [μm] | [μm] |
| Example 1 | Aramid | Polyethylene | −20 | 40 | 135 | 16 | 0.46 |
| Example 2 | Aramid | Polyethylene | −20 | 40 | 135 | 16 | 0.46 |
| Example 3 | Aramid | Polyethylene | −20 | 40 | 135 | 16 | 0.46 |
| Example 4 | Aramid | Polyethylene | −20 | 40 | 135 | 16 | 0.46 |
| Example 5 | Aramid | Polyethylene | −20 | 40 | 135 | 16 | 0.46 |
| Example 6 | Aramid | Polyethylene | −20 | 40 | 135 | 16 | 0.46 |
| Example 7 | Aramid | Polyethylene | −20 | 40 | 135 | 16 | 0.36 |
| Example 8 | PVDF | Polyethylene | −20 | 40 | 135 | 16 | 0.46 |
| Example 9 | Aramid | Polypropylene | −20 | 40 | 170 | 18 | 0.52 |
| Comparative | Aramid | Polyethylene | −20 | 40 | 135 | 16 | 0.46 |
| Example 1 | | | | | | | |
| Comparative | Aramid | Polyethylene | −20 | 40 | 135 | 16 | 0.46 |
| Example 2 | | | | | | | |
| Comparative | Aramid | Polyethylene | −20 | 40 | 135 | 16 | 0.46 |
| Example 3 | | | | | | | |
| Comparative | Aramid | Polyethylene | −20 | 40 | 135 | 16 | 0.46 |
| Example 4 | | | | | | | |
| Comparative | Aramid | Polyethylene | −20 | 40 | 135 | 16 | 0.46 |
| Example 5 | | | | | | | |
| Comparative | Aramid | Polyethylene | −20 | 40 | 135 | 16 | 0.46 |
| Example 6 | | | | | | | |

| | Heat treatment process | | | During coating | | | |
|---|---|---|---|---|---|---|---|
| | | | Period | | Elongation | | |
| | Heat | | of | Tensile | of | Evaluation | |
| | treatment | Temperature | time | stress | substrate | Coating | Internal |
| | method | T [° C.] | [sec] | [N] | [%] | quality | stress |
| Example 1 | Hot plate | 60 | 1.2 | 9 | 0.1 | A | A |
| Example 2 | Hot plate | 60 | 1.2 | 40 | 0.5 | A | A |
| Example 3 | Hot plate | 60 | 1.2 | 60 | 1.9 | A | B |
| Example 4 | Infrared | 60 | 3.0 | 9 | 0.1 | A | A |
| | light | | | | | | |
| Example 5 | Infrared | 40 | 3.0 | 40 | 0.5 | B | A |
| | light | | | | | | |
| Example 6 | Hot plate | 100 | 1.2 | 12 | 1.2 | B | A |
| Example 7 | Hot plate | 80 | 1.2 | 60 | 1.8 | A | B |
| Example 8 | Hot plate | 60 | 1.2 | 9 | 0.1 | A | A |
| Example 9 | Hot plate | 80 | 1.2 | 10 | 1.9 | A | B |
| Comparative | No treatment (Normal | | 0 | 9 | 0.1 | C | B |
| Example 1 | temperature, 20° C.) | | | | | | |
| Comparative | No treatment (Normal | | 0 | 40 | 0.5 | B | C |
| Example 2 | temperature, 20° C.) | | | | | | |
| Comparative | No treatment (Normal | | 0 | 60 | 2.1 | A | C |
| Example 3 | temperature, 20° C.) | | | | | | |
| Comparative | Hot plate | 35 | 1.2 | 9 | 0.1 | C | B |
| Example 4 | | | | | | | |
| Comparative | Hot plate | >135 | 1.2 | Unable to transport and coat due to | | | |
| Example 5 | | | | melting of substrate | | | |
| Comparative | Hot plate | 60 | 1.2 | 9 | 2.5 | C | C |
| Example 6 | | | | | | | |

As can be seen from Table 1, it is possible to stably form a highly uniform coating layer and to reduce the internal stress of the composite film, by subjecting each of the porous substrate to the predetermined heat treatment in advance, before coating the coating liquid on the porous substrate. A favorable result was obtained regardless of using either polyethylene or polypropylene as the porous substrate.

In contrast, in each of Comparative Examples 1 to 4 in which the predetermined heat treatment was not carried out, the formed coating layer was not uniform, and there was a case in which a coating defect(s) was/were observed in a portion of the porous substrate. Further, in Comparative Example 3 in which a high stress was applied to the porous substrate during the coating, the obtained composite film had a high internal stress, resulting in a failure to maintain a desired shape. In Comparative Example 6, although the porous substrate was subjected to the heat treatment, the obtained composite film also had a high internal stress, resulting in a failure to maintain a desired shape.

In Comparative Example 5 in which the heat treatment was carried out at a temperature higher than the melting point of the porous substrate, melting of the substrate itself was observed, thereby complicating the transport and the coating of the substrate.

The disclosure of Japanese Patent Application No. 2015-073079 is incorporated herein by reference in their entirety.

All publications, patent applications, and technical standards mentioned in the present specification are incorporated herein by reference to the same extent as if such individual publication, patent application, or technical standard was specifically and individually indicated to be incorporated by reference.

1. A method of manufacturing a composite film, the method comprising:
subjecting a porous substrate containing a thermoplastic resin to a heat treatment at a temperature T which satisfies the following Formula:
Tg+60° C.≦temperature T≦Tm
wherein Tg represents a glass transition temperature (° C.) of the thermoplastic resin contained in the porous substrate, and Tm represents a melting point (° C.) of the thermoplastic resin contained in the porous substrate;
coating a coating liquid containing at least a resin and a solvent on one surface or both surfaces of the porous substrate, which has been subjected to the heat treatment, to form a coating layer, with a tensile stress in a machine direction in the porous substrate adjusted to be within a range in which an elongation of the porous substrate is 2% or less; and
solidifying the coating layer to obtain a composite film including the porous substrate and a porous layer containing at least the resin formed on one surface or both surfaces of the porous substrate.

2. The method of manufacturing a composite film according to claim 1, wherein a mean value of a thickness of the porous substrate before being subjected to the heat treatment is from 5 μm to 50 μm.

3. The method of manufacturing a composite film according to claim 1, wherein a standard deviation of a thickness of the porous substrate before being subjected to the heat treatment is from 0.40 μm to 30 μm.

4. The method of manufacturing a composite film according to claim 1, wherein a glass transition temperature of the porous substrate before being subjected to the heat treatment is 30° C. or lower.

5. The method of manufacturing a composite film according to claim 1, wherein solidifying the coating layer to obtain a composite film is carried out by bringing the coating layer into contact with a solidifying liquid to solidify the resin, to obtain the composite film including the porous substrate and the porous layer containing at least the resin formed on one surface or both surfaces of the porous substrate.

6. The method of manufacturing a composite film according to claim 1, wherein the coating liquid further comprises a filler, and the porous layer obtained by solidifying the coating layer further comprises the filler.
